(19) United States
(12) Patent Application Publication
(10) Pub. No.: US 2015/0092257 A1
(43) Pub. Date: Apr. 2, 2015

(54) LASER SCANNING DEVICE AND CALIBRATION METHOD THEREOF

(71) Applicant: CORETRONIC CORPORATION, HSIN-CHU (TW)

(72) Inventors: YUNG-CHIH CHEN, Hsin-Chu (TW); HUNG-CHUN HSU, Hsin-Chu (TW)

(21) Appl. No.: 14/323,197

(22) Filed: Jul. 3, 2014

(30) Foreign Application Priority Data
Sep. 29, 2013 (CN) 201310454806.3

(51) Int. Cl. G02B 26/10

(52) U.S. Cl. CPC G02B 26/105
USPC 359/213.1

(57) ABSTRACT

A laser scanning device and a calibration method thereof are provided. The laser scanning device includes a light-emitting element, an oscillating reflective element, a light receiving element and a micro processing unit. The oscillating reflective element is configured to swing back and forth in an adjustable oscillation frequency, such that laser beams emitted from the light-emitting element are reflected to a predetermined scan region. When a swing angle of the oscillating reflective element is affected by a change of the environment temperature, an oscillation frequency of the laser scanning device is directly changed corresponding to the current environment temperature by the micro processing unit such that the oscillating reflective element correctly swings in a predetermined angle range.

### FIELD OF THE INVENTION

The invention relates to a laser scanning device and a calibration method thereof, and more particularly to a laser scanning device capable of calibrating a laser swing angle according to the current environment temperature.

### BACKGROUND OF THE INVENTION

As the touch technology continuously progresses, when the position touch sensing is to be performed on a wide plane, not only the pressure sensitive type touch screen but also the surface scanning type optical touch system can be applied so as to determine the corresponding coordinate of the touch point on the plane as a basis of image interactions.

A conventional surface scanning type optical touch system includes a laser transmitter, an oscillating reflective element, a sensor and an optical receiver. The oscillating reflective element is, for example, an oscillating reflective mirror controlled by a voltage. The oscillating reflective element is configured to swing back and forth in a predetermined angle range, and is disposed at a corner of a plane. The optical receiver and the laser transmitter are disposed at two sides of the plane, wherein the two sides are adjacent to the oscillating reflective element, respectively. When the laser transmitter emits laser beams toward the oscillating reflective element, the laser beams will be reflected to the entire surface of the plane along with the swinging of the oscillating reflective element. When the laser beams are reflected to a direction of the optical receiver, whether the swing frequency of the oscillating reflective element is correct or not can be determined based on the laser light quantity received by the optical receiver.

During the touch process, when a finger of a user touches or approaches the surface that is scanned by the laser beams, the laser beams will be reflected by the finger of the user and transmitted to the sensor. Then, a coordinate of the finger on the surface can be identified by the sensor based on the swing angle and the irradiated position of the laser beams. If the conventional surface scanning type optical touch system is applied to a large-scale liquid crystal screen, the screen can be driven to display a corresponding image at the same time according to the position the user touched on the screen, thereby achieving the effects of touching and interactions.

However, the swing angle of the oscillating reflective element changes along with the temperature change, thereby the angle that the laser beams being reflected would shift. This causes a decrease in the precision of touch sensing. In order to resolve the problem of the angle shift caused by a change in the swing frequency due to the temperature change, a conventional method as follows is used. That is, a corresponding frequency value to be adjusted is firstly preset, then the frequency value is gradually approximated up or down by a fine-tuning range until the swing angle of the oscillating reflective element reaches a value within the predetermined standard range.

However, during the adjusting process of the conventional method, it is necessary to slowly fine-tune the frequency value such that the swing angle of the oscillating reflective element is gradually approximated to the predetermined standard range. In addition, whether the received laser light quantity conforms to the standard value or not must be determined by the optical receiver in every adjusting process. The environment temperature would substantially change, for example, in an air-conditioned room; and even the heat generated by the laser and the liquid crystal screen themselves would cause a significant change of the environment temperature. However, the larger the temperature difference, the more the frequency must be adjusted. As a result, if the conventional adjusting method is used, it would take considerable time and effort to slowly fine-tune the frequency, determine the received laser light quantity by the optical receiver, and then repeat the adjusting processes.

Therefore, it is an object of the invention to instantly and rapidly adjust the swing angle of the oscillating reflective element according to the change in the current environment temperature when the swing angle of the oscillating reflective element is affected by the environment temperature and the abnormity is detected, such that the laser beams can correctly scan the surface range and the convenience in use can be increased.

### SUMMARY OF THE INVENTION

An object of the invention is to provide a calibration method for a laser scanning device that can directly and rapidly adjust the swing frequency when the swing angle of the oscillating reflective element generates an abnormity due to a change in the environment temperature.

Another object of the invention is to provide a calibration method for a laser scanning device that can rapidly adjust the oscillation frequency of the oscillating reflective element based on the current environment temperature.

Another object of the invention is to provide a laser scanning device that can directly adjust the oscillation frequency of the oscillating reflective element such that the oscillating reflective element swings back and forth within the predetermined angle range corresponding the current environment temperature, so as to increase the calibration speed of the laser scanning device.

According to an embodiment of the invention, a calibration method for a laser scanning device is provided, wherein the laser scanning device scans at least a light reflective object in a predetermined scan region, the laser scanning device comprises: at least a light-emitting element for emitting laser beams in a laser emitting direction; at least an oscillating reflective element disposed in the laser emitting direction and swinging back and forth in an oscillation frequency in a predetermined angle range such that the predetermined scan region is scanned by the laser beams; at least a light receiving element for receiving the laser beams reflected by the oscillating reflective element; and a micro processing unit for driving the oscillating reflective element and is electrically connected with the light receiving element, the micro processing unit storing a standard light quantity range value and a plurality of compensation values, wherein the plurality of compensation values are used to compensate the oscillation frequency of the oscillating reflective element in different environment temperatures, the calibration method comprises the following steps:

a) generating a corresponding light quantity value based on the laser beams received by the light receiving element by the micro processing;

b) determining whether the light quantity value conforms to the standard light quantity range value or not;

c) if the light quantity value does not conform to the standard light quantity range value, directly selecting one of the plurality of compensation values that corresponds to the current environment temperature by the micro processing unit; and

d) adjusting the oscillation frequency of the oscillating reflective element based on the compensation value such that the light quantity value of the laser beams received by the light receiving element conforms to the standard light quantity range value.

In an embodiment of the invention, the laser scanning device further includes a temperature sensing element electrically connected with the micro processing unit for sensing the current environment temperature to generate a temperature value, and each of the compensation values has a corresponding temperature control value, the step c) further includes the following steps:

c1) receiving the temperature value from the temperature sensing element by the micro processing unit; and

c2) selecting one of the plurality of compensation values that corresponds to the temperature control value based on the temperature value.

In an embodiment of the invention, each of the compensation values has a corresponding light intensity range difference, and the step c) further includes the following steps:

c1) analyzing a difference between the light quantity value and the standard light quantity range value by the micro processing unit; and

c2) selecting one of the compensation values that corresponds to the light intensity range difference based on the difference.

The oscillation frequency of the oscillating reflective element has a high level signal and a low level signal in a unit cycle, and the step d) further includes a step d1) adjusting the oscillation frequency of the oscillating reflective element by sequential timing controlling a ratio of the high level signal and the low level signal in the unit cycle by the micro processing unit.

In an embodiment of the invention, a curve representing a relationship between the light quantity value and the unit cycle is obtained, the step d1) further includes a step of generating an adjusted light quantity value by the light receiving element, and calculating a minimum amount of difference between a unit cycle corresponding to the adjusted light quantity value and a unit cycle corresponding to the standard light quantity range value based on the curve, so as to adjust the oscillation frequency of the oscillating reflective element by adjusting the ratio of the high level signal and the low level signal in a unit cycle.

According to an embodiment of the invention, a laser scanning device is also provided. The laser scanning device for scanning at least a light reflective object in a predetermined scan region includes at least a light-emitting element for emitting laser beams in a laser emitting direction; at least an oscillating reflective element disposed in the laser emitting direction of a corresponding light-emitting element, and swinging back and forth in an oscillation frequency in a predetermined angle range such that the predetermined scan region is scanned by the laser beams; at least a light receiving element for receiving the laser beams; and a micro processing unit for storing a standard light quantity range value and a plurality of compensation values, wherein the plurality of compensation values are used to compensate the oscillation frequency of the oscillating reflective element in different environment temperatures, the micro processing unit is used to drive the oscillating reflective element and is electrically connected with the light receiving element, a corresponding light quantity value is generated based on the laser beams received by the light receiving element and whether the light quantity value conforms to the standard light quantity range value or not is determined by the micro processing unit, when the light quantity value does not conform to the standard light quantity range value, one of the plurality of compensation values that corresponds to the current environment temperature is directly selected to adjust the oscillation frequency of the oscillating reflective element based on the compensation value by the micro processing unit such that the light quantity value of the laser beams received by the light receiving element conforms to the standard light quantity range value.

The laser scanning device and the calibration method thereof of the invention can directly and rapidly adjust the swing frequency when the swing angle of the oscillating reflective element generates an abnormity due to a change in the environment temperature, so as to meet the requirement in the current environment temperature. Therefore, there is no need to slowly fine tune the frequency value to gradually approximate the swing angle to the predetermined standard range. The calibration method of the invention not only provides a faster adjusting speed, but also increases the convenience of use and achieves all of the above objects.

### BRIEF DESCRIPTION OF THE DRAWINGS

The invention will become more readily apparent to those ordinarily skilled in art after reviewing the following detailed description and accompanying drawings, in which:

FIG. 1 is a schematic diagram showing a laser scanning device according to an embodiment of the invention;

FIG. 2 is a block diagram showing the laser scanning device shown in FIG. 1;

FIGS. 3A and 3B is a flowchart showing a calibration method for a laser scanning device according to an embodiment of the invention;

FIG. 4 is a line graph showing an oscillation frequency of the oscillating reflective element of the laser scanning device shown in FIGS. 3A and 3B; in which a ratio of a high level signal and a low level signal in a unit cycle is shown;

FIG. 5 shows a curve representing a relationship between a light quantity value and a unit cycle D of the laser scanning device shown in FIG. 1 in a normal environment temperature;

FIG. 6 shows a curve representing a relationship between a light quantity value and a unit cycle measured when the environment temperature of FIG. 5 is changed;

FIG. 7 shows a curve representing a relationship between a light quantity value and a unit cycle measured when the oscillation frequency of the oscillating reflective element of FIG. 6 is changed;

FIG. 8 is a block diagram showing a laser scanning device according to an embodiment of the invention; and

FIGS. 9A and 9B is a flowchart showing a calibration method for a laser scanning device according to an embodiment of the invention.

### DETAILED DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

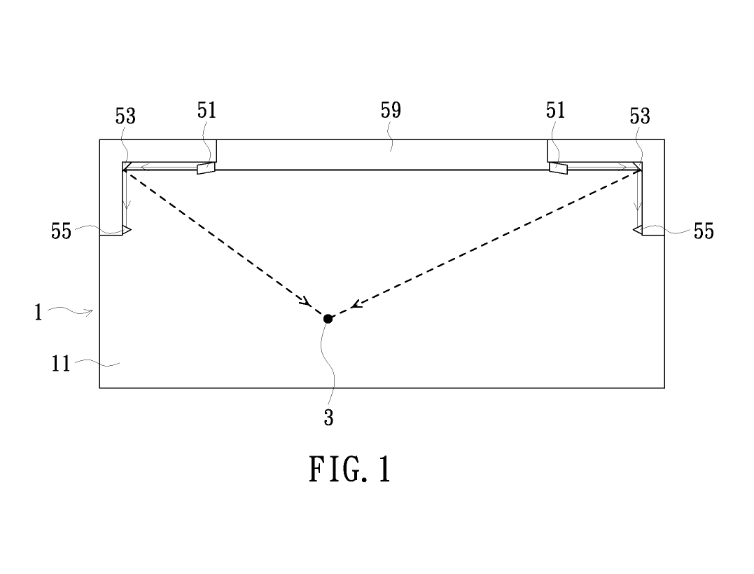

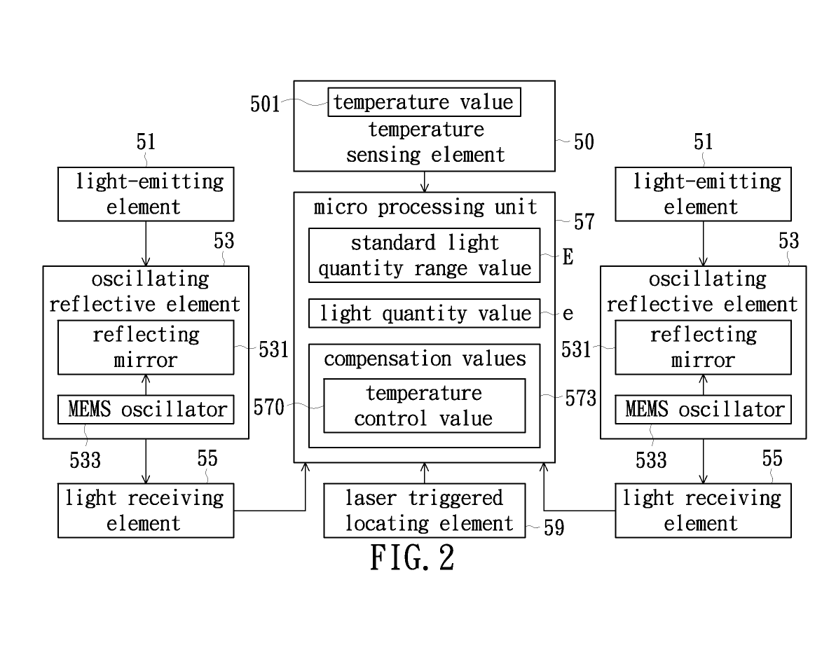

FIG. 1 is a schematic diagram showing a laser scanning device according to an embodiment of the invention, and FIG. 2 is a block diagram showing the laser scanning device shown in FIG. 1. As shown in FIG. 1, the laser scanning device is provided for scanning at least an object 3 that can reflect light beams in a predetermined scan region 11. For example, the laser scanning device may, but not limited to, be disposed on a large-scale liquid crystal screen 1. However, the laser scanning device can also be disposed on a substrate without any display function such as a glass substrate, a plastic substrate etc. The predetermined scan region 11 may be, but not limited to, a planar rectangular area on the screen 1. However, the shape or position of the predetermined scan region 11 can be designed based on actual practices. The object 3 may be a finger of a user. However, the object 3 can also be a touch pen or other object capable of reflecting light beams.

Referring to FIGS. 1 and 2, the laser scanning device in this embodiment includes two light-emitting elements 51, two oscillating reflective elements 53, two light receiving elements 55, a micro processing unit 57, a laser triggered locating element 59 and a temperature sensing element 50. The light-emitting elements 51 can be laser transmitters disposed on the same side of the screen 1. The light-emitting elements 51 emit laser beams toward two opposite terminals of the side, respectively. The oscillating reflective elements 53 are disposed at the opposite terminals of the side and in the laser emitting directions of corresponding light-emitting elements 51, respectively. In the embodiment, each of the oscillating reflective elements 53 includes a reflecting mirror 531 and a Micro Electro Mechanical System (MEMS) oscillator 533. The MEMS oscillator 533 controls the reflecting mirror 531 such that the reflecting mirror 531 is configured to swing back and forth within a predetermined angle range. In the embodiment, the angle range of the reflecting mirror 531 is preset to be between 0 and 90 degree. Therefore, when the laser beams emitted from the light-emitting element 51 is transmitted to the reflecting mirror 531, the reflecting mirror 531 that is configured to swing back and forth can reflect the laser beams to any direction in the predetermined angle range. In this way, the region scanned by the reflected laser beams in the predetermined angle range can cover the entire predetermined scan region 11.

The light receiving elements 55 are respectively disposed at two sides adjacent to the side where the light-emitting elements 51 are located and in a transmission path of the laser beams reflected by the corresponding oscillating reflective element 53, for receiving the reflected laser beams. The micro processing unit 57 is electrically connected with the two light receiving elements 55, and a standard light quantity range value E and a plurality of compensation values 573 are stored in the micro processing unit 57. The compensation values 573 are used to compensate oscillation frequencies of the oscillating reflective element 53 in different environment temperatures. Each of the compensation values 573 has a corresponding temperature control value 570, respectively. The temperature sensing element 50 is electrically connected with the micro processing unit 57, for sensing the current environment temperature to generate a corresponding temperature value 501, which is then transmitted to the micro processing unit 57. The environment temperature can be, but not limited to, a temperature measured at the location of the laser scanning device, or an operating temperature measured by a built-in device during the operation of the laser scanning device.

When an object (ex. a finger of a user) 3 touches or approaches the scan region 11 of the screen 1, the object 3 will be irradiated by the laser beams reflected from the oscillating reflective elements 53 so that reflected light beams are generated. Then, the reflected light beams are received by the laser triggered locating element 59 so that a signal is generated. The signal is provided to the micro processing unit 57, and a position of object 3 in the scan region 11 of the screen 1 is then calculated by the micro processing unit 57. For example, an angle between each oscillating reflective element 53 and the corresponding reflected light beams is analyzed at first, and then a known interval between two oscillating reflective elements 53 is used to convert a coordinate position of the object 3 touching or approaching the screen 1. In the embodiment, the laser triggered locating element 59 is disposed on the side of the screen 1 and between two light-emitting elements 53. However, the position of the laser triggered locating element 59 is not limited to the above and the laser triggered locating element 59 can be disposed at different positions based on actual practices.

Of course, it is obvious to those skilled in the art that the laser scanning device can include two or more light-emitting elements 51, two or more oscillating reflective elements 53 and two or more light receiving elements 55; or the laser scanning device can includes only one light-emitting element 51, one oscillating reflective element 53 and one light receiving element 55. However, in each case, the laser beams reflected from the object 3 can be received by the laser triggered locating element 59, and the correspondingly generated signal can be provided to the micro processing unit 57, and then the touch position of the object 3 on the screen 1 can be determined and calculated by the micro processing unit 57.

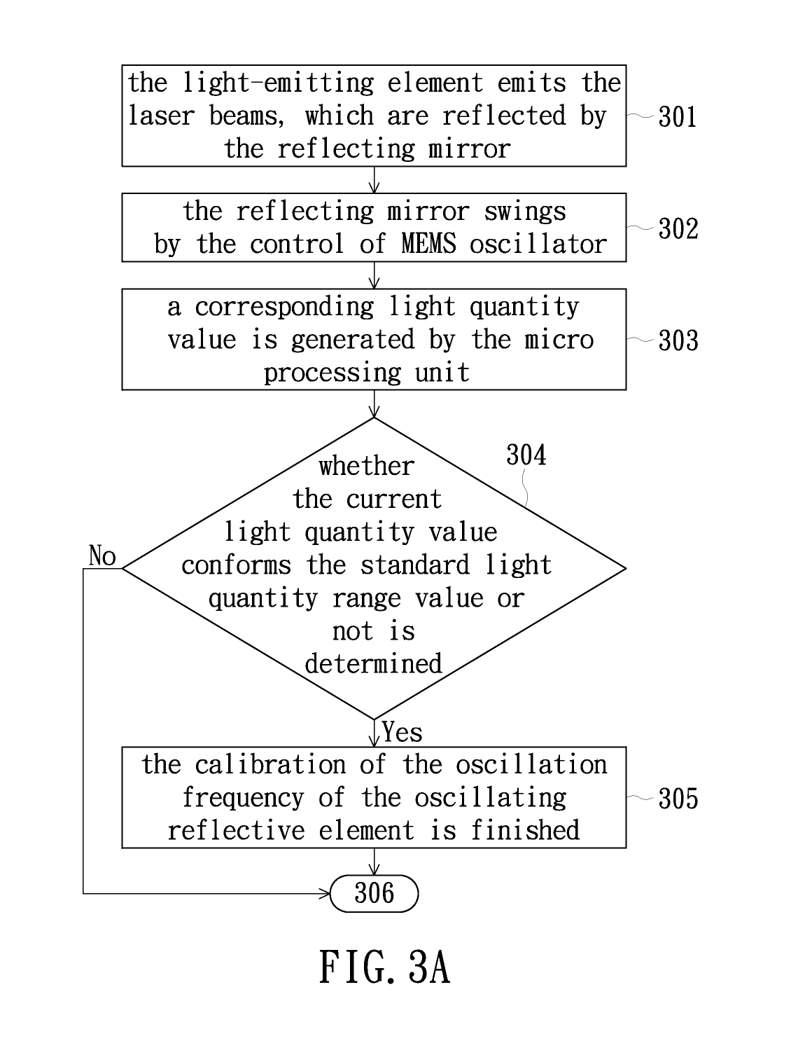

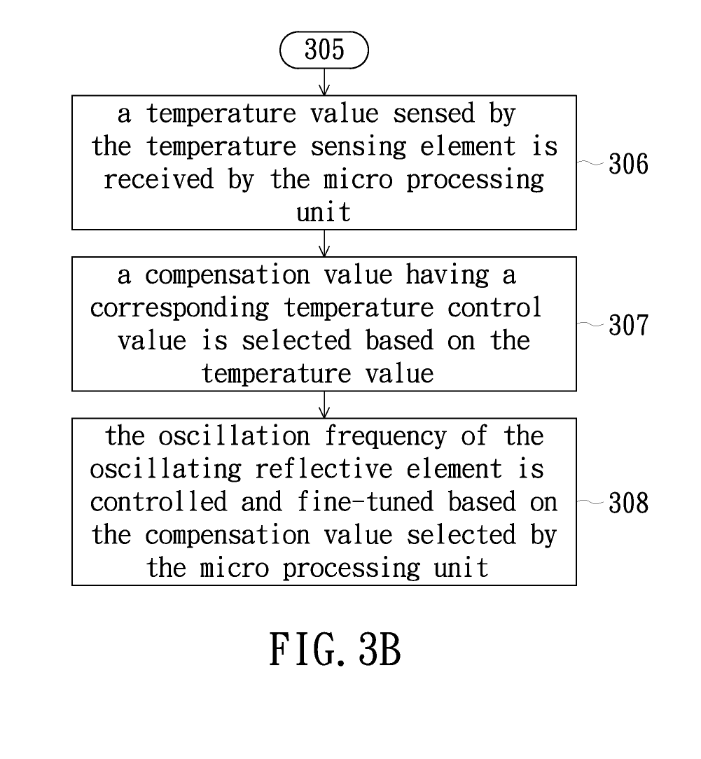

FIGS. 3A and 3B is a flowchart showing a calibration method for a laser scanning device according to an embodiment of the invention. FIG. 4 is a line graph showing an oscillation frequency of the oscillating reflective element of the laser scanning device shown in FIGS. 3A and 3B. In FIG. 4, the proportion of a high level signal and a low level signal in a unit cycle is sequential timing controlled so as to change the oscillation frequency of the oscillating reflective element. Referring to FIGS. 3A and 3B, the calibration method for a laser scanning device in this embodiment includes the following steps. That is, the light-emitting element 51 emits the laser beams, which are reflected by the reflecting mirror 531 of the oscillating reflective element 53 (step 301); the reflecting mirror 531 is controlled by the MEMS oscillator 533 such that the reflecting mirror 531 swings back and forth within the predetermined angle range (step 302). In the embodiment, the angle range may be, but not limited to, 0 to 90°. In this way, the scan region 11 is scanned by the reflected laser beams.

Next, a corresponding light quantity value e is generated by the micro processing unit 57 based on the laser beams received by the light receiving element 55 (step 303). Then, whether the current light quantity value e conforms to the standard light quantity range value E or not is determined (step 304).

If the current light quantity value e conforms to the standard light quantity range value E, then the calibration of the oscillation frequency of the oscillating reflective element 53 will be finished as shown by step 305. If it does not conform, then a temperature value 501 corresponding to the current environment temperature sensed by the temperature sensing element 50 is received by the micro processing unit 57 as shown by step 306. Then, as shown by step 307, a compensation value 573 having a control temperature value 570 corresponding to the temperature value 501 is selected.

Next, the oscillation frequency of the oscillating reflective element 53 is controlled and substantially adjusted based on the compensation value 573 selected by the micro processing unit 57. Referring to FIG. 4, there are a high level signal 538 and a low level signal 537 in each unit cycle D of the oscillation frequency, which is a Pulse Width Modulation (PWM). In the embodiment, the oscillation frequency of the oscillating reflective element 53 can be changed by simply sequential timing changing the ratio of the high level signal 538 and the low level signal 537 in the unit cycle D by the micro processing unit 57. Therefore, after the oscillation frequency of the oscillating reflective element 53 is substantially adjusted by the micro processing unit 57 based on the selected compensation value 573, a minimum amount of difference d between a unit cycle D corresponding to the adjusted light quantity value e and a unit cycle D corresponding to the standard light quantity range value E is calculated. Then, the ratio of the high level signal 538 and the low level signal 537 in the unit cycle D is fine-tuned based on the minimum amount of difference d. In this way, the oscillation frequency of the oscillating reflective element 53 can be correspondingly fine-tuned such that the swing angle of the oscillating reflective element 53 can be maintained in the predetermined angle range corresponding to the current environment temperature (step 308).

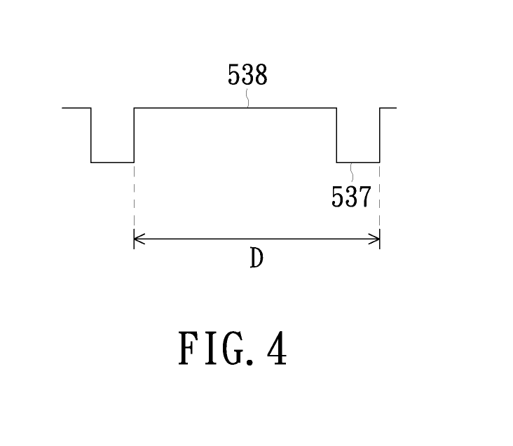

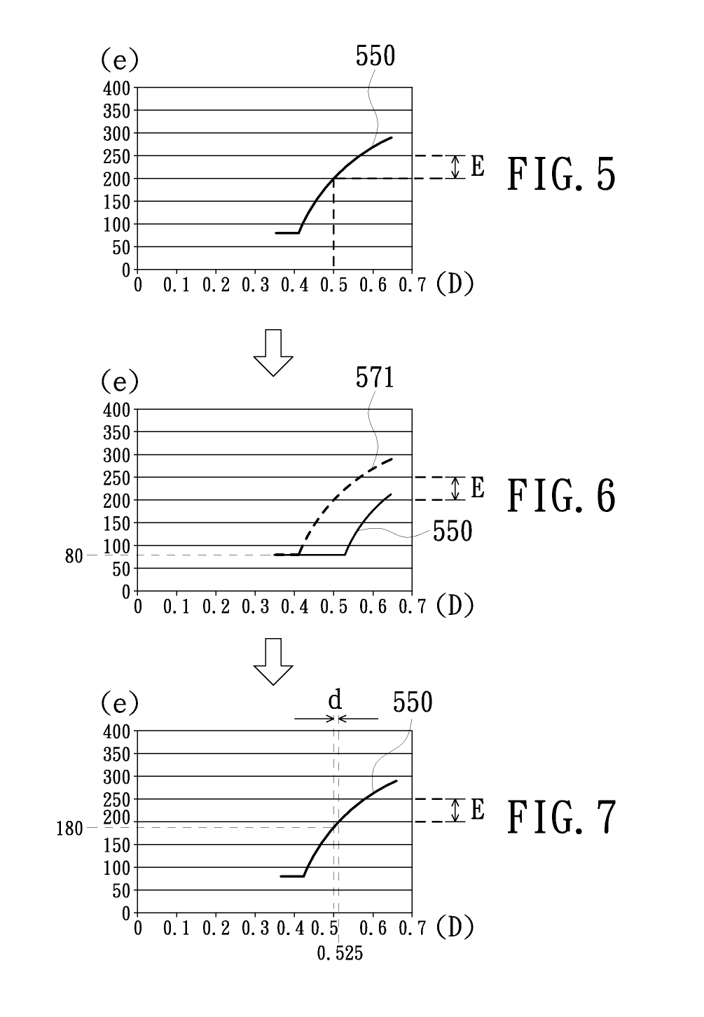

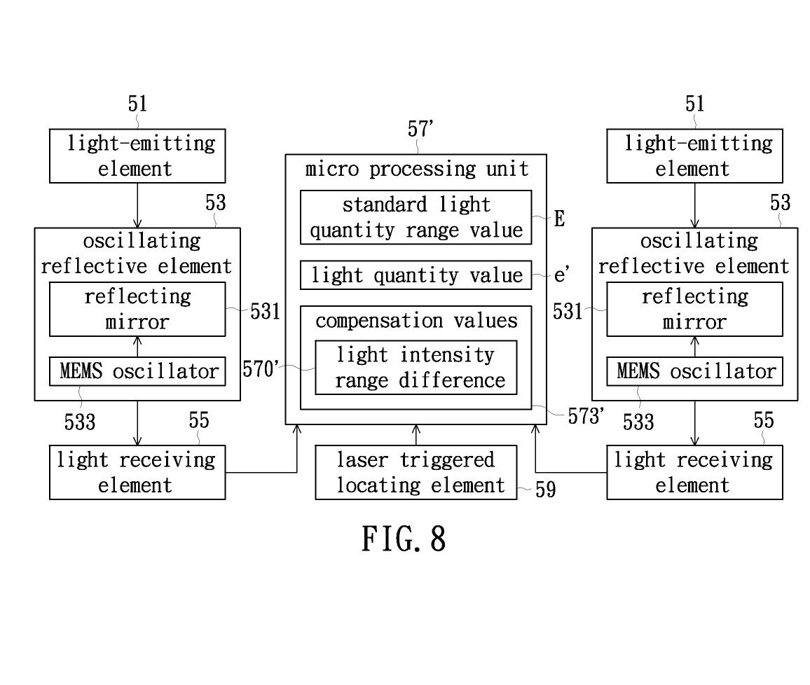

Referring to FIGS. 2 and 5-7 at the same time, FIG. 5 shows a curve 550 representing a relationship between the light quantity value e and the unit cycle D of the laser scanning device 1 shown in FIG. 1 in a normal environment temperature; FIG. 6 shows the curve 550 representing the relationship between the light quantity value e and the unit cycle D measured when the environment temperature of FIG. 5 is changed; and FIG. 7 shows the curve 550 representing the relationship between the light quantity value e and the unit cycle D measured when the oscillation frequency of the oscillating reflective element of FIG. 6 is changed. In an embodiment of the invention, the curve 550 representing the relationship between light quantity value e and unit cycle D under an environment temperature of about 30° C. is as show in FIG. 5, wherein the horizontal axis represents the unit cycle D and the vertical axis represents the light quantity value e. Different curves 550 would be correspondingly obtained by the laser scanning device in different environment temperatures. For example, when the environment temperature is 30° C., the curve 550 as shown in FIG. 5 is obtained; however, when the environment temperature rises to 40° C., the curve 550 representing the relationship between the light quantity value e and the unit cycle D will be changed. That is, the swing angle of the oscillating reflective element 53 is changed due to the influence by the temperature change. In this case, the curve 550 representing the relationship between the light quantity value e and the unit cycle D is as shown in FIG. 6. If the corresponding curve 550 at the temperature value 501 of 30° C. sensed by the temperature sensing element 50 is preset to be a standard curve 571, then the above steps 306 to step 308 are performed such that a compensation value 573 having a corresponding temperature control value 570 is selected by the micro processing unit 57 based on the temperature value 501 sensed by the temperature sensing element 50. Then, the oscillation frequency of the oscillating reflective element 53 is adjusted based on the compensation value 573, such that the curve 550 shown in FIG. 6 is rapidly adjusted to the curve 550 shown in FIG. 7, that is, rapidly adjusted to the standard curve 571.

For example, as shown in FIGS. 1-3 and 5, if the standard light quantity range value E is preset to be 200˜250 and when the environment temperature is 30° C., the unit cycle D of the oscillating reflective element 53 is about 0.5. In this case, the light quantity value e generated by the light receiving element 55 is 200, the light quantity value e will be determined by the micro processing unit 57 that it conforms to the standard light quantity range value E, and the calibration to the oscillation frequency will not be performed. However, if the environment temperature rises to 40° C. suddenly, the light quantity value e generated by the light receiving element 55 will decrease sharply. For example, when the unit cycle D of the curve 550 is 0.5 as shown in FIG. 6, the light quantity value e decreases to 80. In this case, the light quantity value e will be determined by the micro processing unit 57 that it does not conform to the standard light quantity range value E. Then, based on the temperature value 501 sensed by the temperature sensing element 50, a compensation value 573 of the control temperature value 570 that corresponds to the temperature value 501 will be selected, and the corresponding compensation value 573 will be used to rapidly adjust the oscillation frequency of the oscillating reflective element 53 by the micro processing unit 57 such that the curve 550 representing the relationship between the light quantity value e and the unit cycle D is adjusted to be a standard curve 571. At this time, when the unit cycle D of the curve 550 is 0.5 as shown in FIG. 7, the light quantity value e is increased to 180. the minimum amount of difference d between the unit cycle D corresponding to the current light quantity value e and the unit cycle D corresponding to the standard light quantity range value E is continuously analyzed and calculated by the micro processing unit 57 based on the curve 550 shown in FIG. 7. Then, the unit cycle D of the oscillating reflective element 53 will be fine-tuned based on the minimum amount of difference d such that its light quantity value e conforms to the standard light quantity range value E. Taking the curve 550 shown in FIG. 7 as an example, if the current adjusted light quantity value e is 180 and the standard light quantity range value E is 200˜250, the minimum amount of difference d between the corresponding unit cycles Ds will be 0.025. In this case, the unit cycle D will be fine-tuned from 0.5 to 0.525 by the micro processing unit 57 based on the minimum amount of difference d such that a light quantity value e of 200 that conforms to the standard light quantity range value E can be obtained by the light receiving element 55.

In the laser scanning device of the invention, the standard light quantity range value E and the plurality of compensation values 573 corresponding to different temperatures are stored in the micro processing unit 57. If the temperature change causes a shift in the swing angle of the oscillating reflective element 53, a corresponding compensation value 573 can be selected by the micro processing unit 57 based on the temperature value 501 of the current environment. Then, the oscillation frequency of the oscillating reflective element 53 is rapidly adjusted such that the curve 550 between the light quantity value e and the unit cycle D is rapidly adjusted to be the standard curve 571. Next, a minimum amount of difference d between a current unit cycle D corresponding to the light quantity value e and a unit cycle D corresponding to the standard light quantity range value E is calculated based on the curve 550 (571), thereby fine-tuning the unit cycle D of the oscillating reflective element 53 such that the light quantity value e can conform to the standard light quantity range value E. By the above calibration method, even if the environment temperature sharply changed, the laser scanning device can also rapidly calibrate the oscillation frequency of the oscillating reflective element 53 such that it can be maintained to swing back and forth within the predetermined angle range.

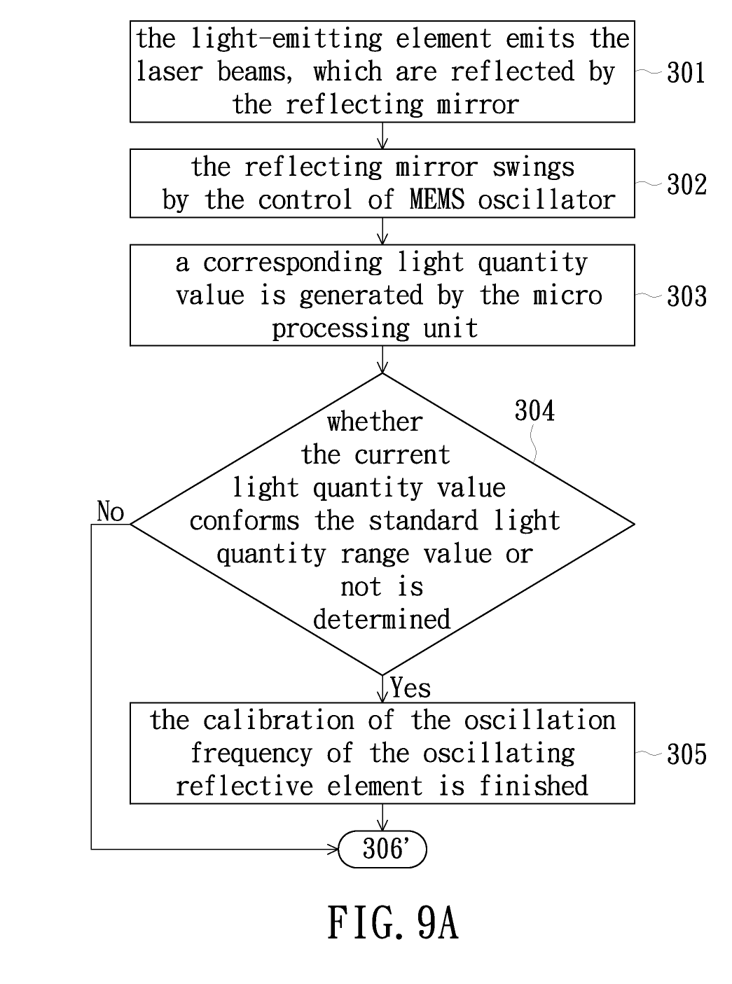

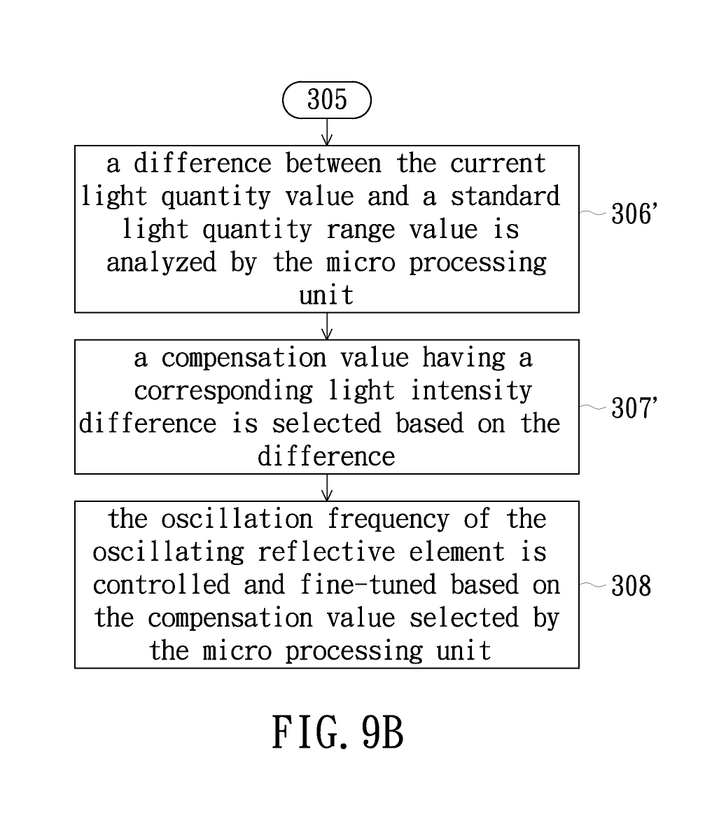

According to another embodiment of the invention, a calibration method for a laser scanning device as shown in FIG. 8 is provided. In this embodiment, compensation values 573′ respectively has a corresponding light intensity range difference 570′. Referring to the flowchart shown in FIGS. 9A and 9B at the same time, when the current light quantity value e′ is determined that it does not conform to a standard light quantity range value E′, a difference between the current light quantity value e′ and a standard light quantity range value E′ can be analyzed directly by the micro processing unit 57′ as shown by step 306′. Then, as shown by step 307′, a compensation value 573′ having a corresponding light intensity range difference 570′ is selected by the micro processing unit 57′ based on the difference analyzed by the micro processing unit 57′. Finally, the oscillation frequency of the oscillating reflective element is controlled and fine-tuned based on the compensation value 573′ selected by the micro processing unit 57.

In this embodiment, since the difference between the light quantity value e′ and the standard light quantity range value E′ is analyzed and used as a reference to select the compensation value 573′. Therefore, the object of directly and rapidly adjusting the swing angle of the oscillating reflective element according to the current environment temperature change can be achieved without disposing any additional temperature sensing element.

Therefore, it can be known from the above that in the laser scanning device and calibration method thereof according to the invention, the current light quantity value of the laser beams received by the light receiving element is determined by the micro processing unit that it does not conform to the preset standard light quantity range value, the oscillation frequency of the oscillating reflective element can be immediately adjusted such that the swing angle of the oscillating reflective element can meet the requirement in the current environment temperature. Therefore, there is no need to slowly fine tune the oscillation frequency value to gradually approximate the swing angle to the predetermined standard range. When comparing with a conventional calibration method, the calibration method of the invention not only provides a faster adjusting speed, but also increases the convenience of use and achieves all of the above objects.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A calibration method for a laser scanning device, the laser scanning device scanning at least a light reflective object in a predetermined scan region, the laser scanning device comprising: at least a light-emitting element for emitting laser beams in a laser emitting direction; at least an oscillating reflective element disposed in the laser emitting direction and swinging back and forth in an oscillation frequency in a predetermined angle range such that the predetermined scan region is scanned by the laser beams; at least a light receiving element for receiving the laser beams reflected by the oscillating reflective element; and a micro processing unit for driving the oscillating reflective element and is electrically connected with the light receiving element, the micro processing unit storing a standard light quantity range value and a plurality of compensation values, wherein the plurality of compensation values are used to compensate the oscillation frequency of the oscillating reflective element in different environment temperatures, the calibration method comprises the following steps:
a) generating a light quantity value based on the laser beams received by the light receiving element;
b) determining whether the light quantity value conforms to the standard light quantity range value or not;
c) if the light quantity value does not conform to the standard light quantity range value, directly selecting one of the plurality of compensation values that corresponds to the current environment temperature by the micro processing unit; and
d) adjusting the oscillation frequency of the oscillating reflective element based on the compensation value such that the light quantity value of the laser beams received by the light receiving element conforms to the standard light quantity range value.

2. The calibration method as claimed in claim 1, wherein the laser scanning device further comprises a temperature sensing element electrically connected with the micro processing unit for sensing the current environment temperature to generate a temperature value, and each of the compensation values has a corresponding temperature control value, the step c) further comprises the following steps:
c1) receiving the temperature value from the temperature sensing element by the micro processing unit; and
c2) selecting one of the plurality of compensation values that corresponds to the temperature control value based on the temperature value.

3. The calibration method as claimed in claim 1, wherein each of the compensation values has a corresponding light intensity range difference, the step c) further comprises the following steps:
c1) analyzing a difference between the light quantity value and the standard light quantity range value by the micro processing unit; and
c2) selecting one of the compensation values that corresponds to the light intensity range difference based on the difference.

4. The calibration method as claimed in claim 2, wherein the oscillation frequency of the oscillating reflective element has a high level signal and a low level signal in a unit cycle, the step d) further comprises the following step:
d1) adjusting the oscillation frequency of the oscillating reflective element by sequential timing controlling a ratio of the high level signal and the low level signal in the unit cycle by the micro processing unit.

5. The calibration method as claimed in claim 3, wherein the oscillation frequency of the oscillating reflective element has a high level signal and a low level signal in a unit cycle, the step d) further comprises the following step:
d1) adjusting the oscillation frequency of the oscillating reflective element by sequential timing controlling a ratio of the high level signal and the low level signal in the unit cycle by the micro processing unit.

6. The calibration method as claimed in claim 4, wherein a curve representing a relationship between the light quantity value and the unit cycle is obtained, and the step d1) further comprises the following step:
generating an adjusted light quantity value by the light receiving element, and calculating a minimum amount of difference between a unit cycle corresponding to the adjusted light quantity value and a unit cycle corresponding to the standard light quantity range value based on the curve, so as to adjust the oscillation frequency of the oscillating reflective element by adjusting the ratio of the high level signal and the low level signal in a unit cycle.

7. The calibration method as claimed in claim 5, wherein a curve representing a relationship between the light quantity value and the unit cycle is obtained, and the step d1) further comprises the following step:
generating an adjusted light quantity value by the light receiving element, and calculating a minimum amount of difference between a unit cycle corresponding to the adjusted light quantity value and a unit cycle corresponding to the standard light quantity range value based on the curve, so as to adjust the oscillation frequency of the oscillating reflective element by adjusting the ratio of the high level signal and the low level signal in a unit cycle.

8. The calibration method as claimed in claim 1 wherein the oscillating reflective element further comprises a reflecting mirror and a Micro Electro Mechanical System oscillator, wherein the step a) further comprises the following steps:
a1) reflecting the laser beams by the reflecting mirror;
a2) controlling the reflecting mirror by the Micro Electro Mechanical System oscillator such that the reflecting mirror swings back and forth within the predetermined angle range.

9. A laser scanning device for scanning at least a light reflective object in a predetermined scan region, the laser scanning device comprising:
at least a light-emitting element for emitting laser beams in a laser emitting direction;
at least an oscillating reflective element disposed in the laser emitting direction of a corresponding light-emitting element, and swinging back and forth in an oscillation frequency in a predetermined angle range such that the predetermined scan region is scanned by the laser beams;
at least a light receiving element for receiving the laser beams; and
a micro processing unit for storing a standard light quantity range value and a plurality of compensation values, wherein the plurality of compensation values are used to compensate the oscillation frequency of the oscillating reflective element in different environment temperatures, the micro processing unit is used to drive the oscillating reflective element and is electrically connected with the light receiving element, a corresponding light quantity value is generated based on the laser beams received by the light receiving element and whether the light quantity value conforms to the standard light quantity range value or not is determined by the micro processing unit, when the light quantity value does not conform to the standard light quantity range value, one of the plurality of compensation values that corresponds to the current environment temperature is directly selected to adjust the oscillation frequency of the oscillating reflective element based on the compensation value by the micro processing unit such that the light quantity value of the laser beams received by the light receiving element conforms to the standard light quantity range value.

10. The laser scanning device as claimed in claim 9, further comprising a temperature sensing element for sensing and generating a temperature value, wherein the temperature sensing element is electrically connected with the micro processing unit, the temperature value is provided to the micro processing unit, each of the plurality of compensation values has a corresponding temperature control value, one of the plurality of compensation values that corresponds to the temperature control value is selected by the micro processing unit based on the temperature value.

11. The laser scanning device as claimed in claim 9, wherein each of the plurality of compensation values has a corresponding light intensity range difference, a difference between the light quantity value and the standard light quantity range value is analyzed, and one of the plurality of compensation values that corresponds to the light intensity range difference is selected based on the difference by the micro processing unit.

12. The laser scanning device as claimed in claim 10, wherein the oscillation frequency of the oscillating reflective element has a high level signal and a low level signal in a unit cycle, the oscillation frequency of the oscillating reflective element is adjusted by sequential timing controlling a ratio of the high level signal and the low level signal in the unit cycle by the micro processing unit.

13. The laser scanning device as claimed in claim 11, wherein the oscillation frequency of the oscillating reflective element has a high level signal and a low level signal in a unit cycle, the oscillation frequency of the oscillating reflective element is adjusted by sequential timing controlling a ratio of the high level signal and the low level signal in the unit cycle by the micro processing unit.

14. The laser scanning device as claimed in claim 12, wherein a curve representing a relationship between the light quantity value and the unit cycle is obtained, after the oscillation frequency of the oscillating reflective element is adjusted based on the compensation value corresponding to the current environment temperature by the micro processing unit, an adjusted light quantity value is generated by the light receiving element, and a minimum amount of difference between a unit cycle corresponding to the adjusted light quantity value and a unit cycle corresponding to the standard light quantity range value is calculated based on the curve, so as to adjust the oscillation frequency of the oscillating reflective element by adjusting the ratio of the high level signal and the low level signal in the unit cycle.

15. The laser scanning device as claimed in claim 13, wherein a curve representing a relationship between the light quantity value and the unit cycle is obtained, after the oscillation frequency of the oscillating reflective element is adjusted based on the compensation value corresponding to the current environment temperature by the micro processing unit, an adjusted light quantity value is generated by the light receiving element, and a minimum amount of difference between a unit cycle corresponding to the adjusted light quantity value and a unit cycle corresponding to the standard light quantity range value is calculated based on the curve, so as to adjust the oscillation frequency of the oscillating reflective element by adjusting the ratio of the high level signal and the low level signal in the unit cycle

16. The laser scanning device as claimed in claim 9, wherein the oscillating reflective element further comprises:
a reflecting mirror for reflecting the laser beams; and
a Micro Electro Mechanical System oscillator for controlling the reflecting mirror such that the reflecting mirror swings back and forth within the predetermined angle range.

17. The laser scanning device as claimed in claim 9, further comprising a laser triggered locating element for receiving the laser beams reflected from the object in the predetermined scan region, wherein the laser triggered locating element is electrically connected with the micro processing unit and the laser beams received are provided to the micro processing unit for determining a position of the object in the predetermined scan region.
